(19) United States
(12) Patent Application Publication
(10) Pub. No.: US 2014/0313605 A1
(43) Pub. Date: Oct. 23, 2014

(54) REFLECTOR ARRANGEMENT, LIGHT CURTAIN, METHOD FOR ADJUSTING THE REFLECTOR ARRANGEMENT AND METHOD FOR ASSEMBLING THE REFLECTOR ARRANGEMENT

(71) Applicant: OMRON Corporation, Kyoto-shi (JP)

(72) Inventors: Michael Bessler, Nufringen (DE); Eugen Gluska, Nufringen (DE)

(73) Assignee: OMRON Corporation, Kyoto-shi (JP)

(21) Appl. No.: 14/253,918

(22) Filed: Apr. 16, 2014

(30) Foreign Application Priority Data
Apr. 17, 2013 (DE) 102013206892.1

(51) Int. Cl. G02B 26/08

(52) U.S. Cl. CPC G02B 26/0816
USPC 359/856; 359/862; 29/464

(57) ABSTRACT

Disclosed is a reflector arrangement including a mirror system for reflecting incident light. The mirror system includes a V-mirror unit with a V-shaped mirror having two mirror reflection surfaces, and a plane mirror unit arranged at a distance from the V-mirror unit. The V-mirror unit includes a V-mirror adjustment mechanism for adjusting an angle between the two mirror reflection surfaces of the V-shaped mirror. A method for adjusting the reflector arrangement and a method for assembling the reflector arrangement are also disclosed.

### CROSS REFERENCE TO RELATED APPLICATIONS

This application claims priority based on 35 USC 119 from prior German Patent Application No. DE102013206892.1 filed on Apr. 17, 2013, entitled “REFLECTOR ARRANGEMENT, LIGHT CURTAIN, METHOD FOR ADJUSTING THE REFLECTOR ARRANGEMENT AND METHOD FOR ASSEMBLING THE REFLECTOR ARRANGEMENT”, the entire contents of which are incorporated herein by reference.

### BACKGROUND

The present invention relates to a reflector arrangement, a light curtain including the reflector arrangement, a method for adjusting the reflector arrangement and a method for assembling the reflector arrangement.

Light curtains are commonly used to detect objects or people entering a protected zone. They are available in a range of different resolutions, with fine resolution models for use in spaces into which only small body parts, such as fingers, can enter, somewhat marginally lower resolution models for use in spaces into which larger body parts, such as hands, can enter, and even lower resolution models for use in spaces that can be entered by an entire human body. The last mentioned are also known as body protection or perimetrical guards.

Body protection light curtains are generally classified into two types of systems: active-active systems and active-passive systems. Both types have in common that they include a transmitter for emitting a light beam and a receiver for receiving that light beam. Typically, when a body part blocks the light beam and the receiver does not receive the light beam anymore, a warning signal or the like is output. In an active-active system, the transmitter and the receiver are placed in separate housings that are arranged on opposite sides of the zone to be protected. In an active-passive system, the transmitter and the receiver are placed in the same housing, and a reflector unit is placed on the opposite side of the zone to be protected. The transmitter emits a light beam passing through the zone to be protected, and the light beam is reflected by a mirror arrangement in the reflector unit back through the zone to be protected towards the receiver. An aspect of the invention relates mainly to active-passive systems, although it can also be integrated into configurations using active-active systems.

An example of an active-passive system is given in EP 1 296 161 A2, which discloses an active-passive system including an active transmitter/receiver unit arranged on one side of the area to be protected and a passive reflector unit on the other side. A transmission light beam from the active transmitter/receiver unit is incident on the reflector unit, which separates it into several spatially separate sub-beams detected by one receiver per sub-beam in the transmitter-receiver unit.

The operating range that can be achieved with an active-passive system depends on the optical power of the transmitter on the active side, the quality of the reflecting surfaces inside the reflector unit, the alignment of the active and the passive sides, as well as on the precision of the assembly inside the reflector unit on the passive side. The last factor means that a precise alignment and fixation after alignment of the mirror arrangement inside the reflector unit on the passive side has a high impact on the operating range that can be achieved.

One possibility to fix the mirror arrangement within the reflector unit is to glue the mirrors with epoxy glue or the like to a metal frame. However, this leads to the problem that when the epoxy glue hardens, stress is exerted on the mirrors, so that the reflection surfaces of the mirrors may be displaced slightly with respect to the desired reflection plane. Since even a very slight deviation of the reflection surfaces leads to a large deviation of the position where the reflected light beam is incident on the receiver-side, a very high precision is required when assembling the mirrors in the reflector unit.

### SUMMARY

In view of the foregoing considerations, it is an object of an aspect of the invention to present a reflector arrangement in which the mirrors can be assembled with greater precision, so that a larger operating range can be achieved. It is a further object of an aspect of the invention to present a light curtain comprising such a reflector arrangement as well as a method for adjusting the reflector arrangement and a method for assembling the reflector arrangement.

To achieve this object, a reflector arrangement according to an embodiment of the invention includes a mirror system for reflecting incident light, the mirror system including a V-mirror unit and a plane mirror unit. The V-mirror unit includes a V-shaped mirror having two mirror reflection surfaces. The plane mirror unit is arranged at a distance from the V-mirror unit. The V-mirror unit includes a V-mirror adjustment mechanism for adjusting an angle between the two mirror reflection surfaces of the V-shaped mirror. Since the angle between the two mirror reflection surfaces of the V-shaped mirror can be adjusted with the adjustment mechanism, it is possible to assemble the reflector arrangement with greater precision. Moreover, when used in a light curtain, the same or a greater operating distance can be accomplished with smaller mirror surfaces. The reflector arrangement including the mirror system may be constituted by a single reflector unit, or may be constituted by two or more reflector units. The V-shaped mirror of the V-mirror unit may be constituted by a single V-shaped angular element or by two plane mirror halves arranged at an angle in a substantially V-shaped arrangement.

In one possible embodiment, the V-mirror unit comprises an elastically deformable V-mirror mounting bracket for supporting the V-shaped mirror, and the V-mirror adjustment mechanism is adapted to elastically deform the V-mirror mounting bracket to adjust the angle between the two mirror reflection surfaces. More specifically, the V-mirror mounting bracket may include a base portion, and two support portions elastically connected to the base portion, each support portion supporting one part of the V-shaped mirror, wherein the V-mirror adjustment mechanism is adapted to adjust the angle between the two mirror reflection surfaces by tilting of at least one of the support portions relative to the base portion. With such an arrangement, the V-mirror mounting bracket can be deformed elastically, so that a very precise adjustment of the angle between the two mirror reflection surfaces becomes possible. Here, “elastic deformation” means that the mounting bracket reverses to its original state when the deforming force is removed.

The V-mirror adjustment mechanism may include, for example, two screws that are mounted in respective screw holes provided in the base portion, the screws being adapted to apply a force on the respective support portion, thereby adjusting the angle between the two mirror reflection surfaces. Accordingly, a very precise adjustment becomes possible with a simple configuration.

Each of the support portions may be elastically connected to the base portion by a web, and the base portion, the support portions and the webs may be constituted in a single piece. Accordingly, a very compact arrangement can be achieved.

The angle between the two mirror reflection surfaces may be smaller than 90 degrees, for example in a range of 89.95 to 89.99 degrees. This makes it possible to focus a divergent light beam at a desired target distance that corresponds to the operating distance of a light curtain including such a reflector arrangement.

The reflector arrangement may further include a frame to which the V-mirror unit and the plane mirror unit are mounted.

Also the plane mirror unit may be made adjustable. For this, the plane mirror unit may include a plane mirror, a plane mirror mounting bracket, and a plane mirror adjustment mechanism for adjusting the orientation of the plane mirror relative to the frame. In particular if the plane mirror unit is adjustable with respect to two degrees of freedom, then it is possible to adjust the reflected light beam such that it is incident precisely on a predetermined target area.

In one possible configuration, the plane mirror mounting bracket includes a plane mirror base portion and a plane mirror support portion that is rotatable with respect to the plane mirror base portion, and the plane mirror adjustment mechanism comprises means for adjusting a rotation angle of the plane mirror support portion with respect to the plane mirror base portion. More specifically, the plane mirror adjustment mechanism may include two screws that are mounted in respective screw holes provided in the plane mirror base portion, and the screws being adapted to apply a force on the plane mirror support portion, thereby rotating the plane mirror support portion with respect to the plane mirror base portion. Accordingly, a very precise adjustment of the plane mirror unit becomes possible with a simple configuration.

The V-mirror adjustment mechanism and/or the plane mirror adjustment mechanism may include an actuator, in particular a piezo actuator, that can be actuated by an actuation signal. This makes it possible to recalibrate the mirror units if necessary.

The mirror system may be adapted to reflect incident light that is incident in a predetermined incident direction in a reflection direction that is parallel to the incident direction. This makes the reflector arrangement particularly suitable for use in a light curtain.

Furthermore, the plane mirror adjustment mechanism may include a screw that is arranged to lift the plane mirror base portion from the frame, thereby rotating the plane mirror support portion with respect to the frame. Thus, the plane mirror unit can be adjusted with a simple configuration.

A light curtain according to the embodiments may include a reflector arrangement as described above, and a transmitter/receiver arrangement for projecting a light beam onto the mirror system and receiving a light beam reflected from the mirror system.

A method for adjusting the above-described reflector arrangement includes the following steps: projecting an incident light beam onto the mirror system; and operating the V-mirror adjustment mechanism to adjust the angle between the two mirror reflection surfaces of the V-shaped mirror such that two reflected light beams reflected by the mirror system overlap at a predetermined distance from the reflector arrangement. This way, the reflector arrangement can be optimized for operation at the predetermined distance.

The adjusting method may further include: operating the plane mirror adjustment mechanism such that a reflected light beam reflected by the mirror system is incident on a predetermined target area. In particular if the plane mirror unit is adjustable with respect to two degrees of freedom, then it is possible to adjust the reflected light beam such that it is incident precisely on a predetermined target area.

A method for assembling a reflector arrangement as described above may include the steps of: mounting the V-mirror unit and the plane mirror unit to the frame; and adjusting the angle between the two mirror reflection surfaces of the V-shaped mirror with the above-described adjustment method.

After the adjustment, a thread-locking sealant may be applied to the V-mirror adjustment mechanism and/or the plane mirror adjustment mechanism to fix their respective adjustment state. This ensures that the V-mirror adjustment mechanism stays in the adjusted position and is not loosened due to vibrations, temperature variations or other environmental influences.

### BRIEF DESCRIPTION OF DRAWINGS

Further embodiments, features and advantages of the present invention will become apparent from the subsequent description and dependent claims, taken in conjunction with the accompanying drawings, in which:

FIG. 1 is a schematic diagram showing a light curtain 1 in accordance with one embodiment;

FIG. 2A and FIG. 2B are each perspective views of a V-mirror unit taken from different sides;

FIG. 2C is a top view of the V-mirror unit;

FIG. 2D is a side view of the V-mirror unit;

FIG. 2E is a rear view of the V-mirror unit;

FIG. 3A and FIG. 3B are each perspective views of a plane mirror unit taken from different sides;

FIG. 3C is a top view of the plane mirror unit;

FIG. 3D is a side view of the plane mirror unit;

FIG. 3E is a rear view of the plane mirror unit;

FIG. 3F is a bottom view of the plane mirror unit;

FIG. 4A is a partially cut-away view of a frame of the reflector unit, to which the V-mirror unit and the plane mirror unit are mounted;

FIG. 4B is an enlarged view of the region enclosed by the circle A in FIG. 4A;

FIG. 4C is an enlarged view of the region enclosed by the circle B in FIG. 4A;

FIG. 5A schematically illustrates the change of the cross-section of a divergent light beam at various distances after a mirror system for the case that the angle between the mirror surfaces of the V-shaped mirror is adjusted to precisely 90 degrees;

FIG. 5B schematically illustrates the change of the cross-section of a divergent light beam at various distances after a mirror system for the case that the angle between the mirror surfaces of the V-shaped mirror is adjusted to slightly less than 90 degrees;

FIG. 6A is a schematic top view of a light curtain in accordance with a further embodiment; and

FIG. 6B is a schematic perspective view of this light curtain.

### EMBODIMENTS

The following is an explanation of embodiments of the invention, with reference to the accompanying drawings. All dimensions, materials and further specific numbers shown in the embodiment are given only by way of example, in order to aid the understanding of the invention, but are not meant to limit the present invention, unless this is explicitly stated so. It should be further noted that throughout this specification and in the drawings, elements that have substantially the same functionality and/or structure are denoted by the same reference numerals, and their duplicate explanation has been omitted. Furthermore, elements that are not directly related to the present invention may not necessarily be shown in the figures.

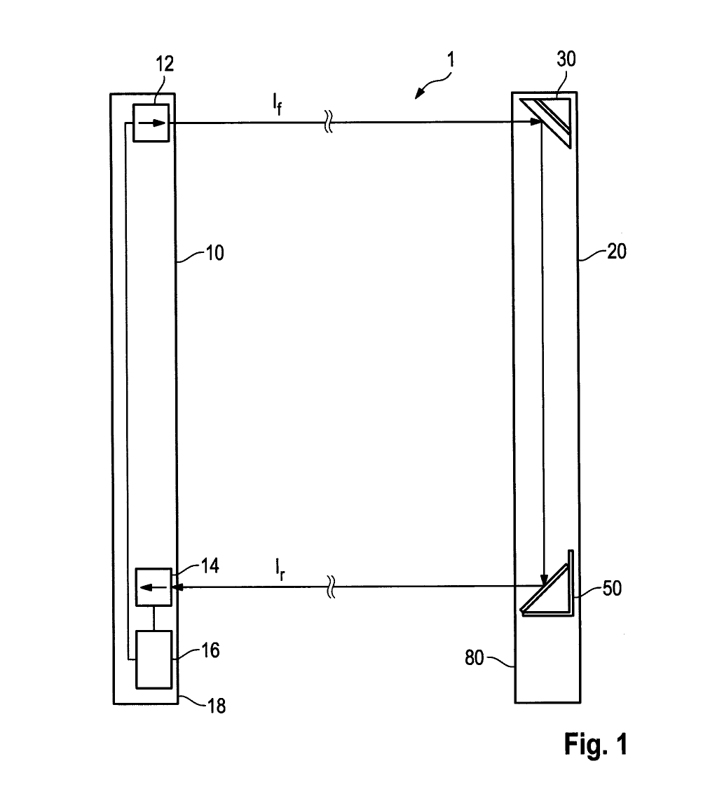

FIG. 1 is a schematic diagram showing a light curtain 1 in accordance with one embodiment of the present invention. The light curtain 1 includes a transmitter/receiver unit 10 (corresponding to a transmitter/receiver arrangement) and a reflector unit 20 (corresponding to a reflector arrangement). The transmitter/receiver unit 10 and the reflector unit 20 are arranged facing each other across a zone to be monitored. The transmitter/receiver unit 10 is an active unit that emits a light beam l_{f} and receives a reflected light beam lᵣ from the reflector unit 20. The reflector unit 20 is a passive unit that deflects the light beam incident on it and reflects the light beam in a direction that is substantially parallel to the incident light beam. The light curtain 1 thus constitutes an active-passive system.

The transmitter/receiver unit 10 includes a transmitter 12, a receiver 14 and a control unit 16, which are arranged in and fixed to a housing or frame 18. The transmitter 12 and the receiver 14 are each connected to and controlled by the control unit 16. The transmitter 12 is an optical transmitter and may be constituted, for example, by an LED that emits infrared light, but there is no limitation thereto. In response to a control signal from the control unit 16, the transmitter 12 emits a light beam in a direction that is substantially perpendicular to the longitudinal axis of the frame 18. Depending on the application, the light beam may be a continuous light beam or a pulsed light beam, for example. Furthermore, a lens or the like may be placed immediately in front of the LED of the transmitter 12, in order to focus the light beam emitted by the LED.

The receiver 14 is an optical receiver that is constituted by an optoelectronic converter, for example. The receiver 14 converts the light beam lᵣ reflected from the reflector unit 20 into an electronic signal, which is supplied to the control unit 16. The control unit 16 evaluates this electronic signal and outputs a detection signal. For example, if the forward light beam l_{f} or the reflected light beam lᵣ is interrupted, then the control unit 16 may output a detection signal that indicates that an object or human body part has entered the zone to be monitored. This may, in turn, trigger a emergency system, which forces a connected device (machine, robot, etc.) to either go into a defined safe state or even immediately stop.

The reflector unit 20 includes a V-mirror unit 30 and a plane mirror unit 50, which are arranged in and fixed to a housing or frame 80. Thus, the reflector unit 20 is a reflector arrangement including a mirror system for deflecting incident light including the V-mirror unit 30 and the plane mirror unit 50. The forward light beam l_{f} is deflected by the V-mirror unit 30 and directed towards the plane mirror unit 50. The plane mirror unit 50, in turn, deflects the light beam in such a direction that it is incident on the receiver 14. The reflected light beam lᵣ reflected by the plane mirror unit 50 is substantially parallel to the forward light beam l_{f} that is incident on the V-mirror unit 30. The V-mirror unit 30 and the plane mirror unit 50 may be arranged at a distance of e.g. 500 mm within the frame 80, but needless to say, this distance may be adjusted as suitable for the desired purpose of the light curtain 1. Moreover, it is of course also possible to turn the reflector unit 20 upside down, such that the forward light beam l_{f} is first incident on the plane mirror unit 50 and deflected from there toward the V-mirror unit 30.

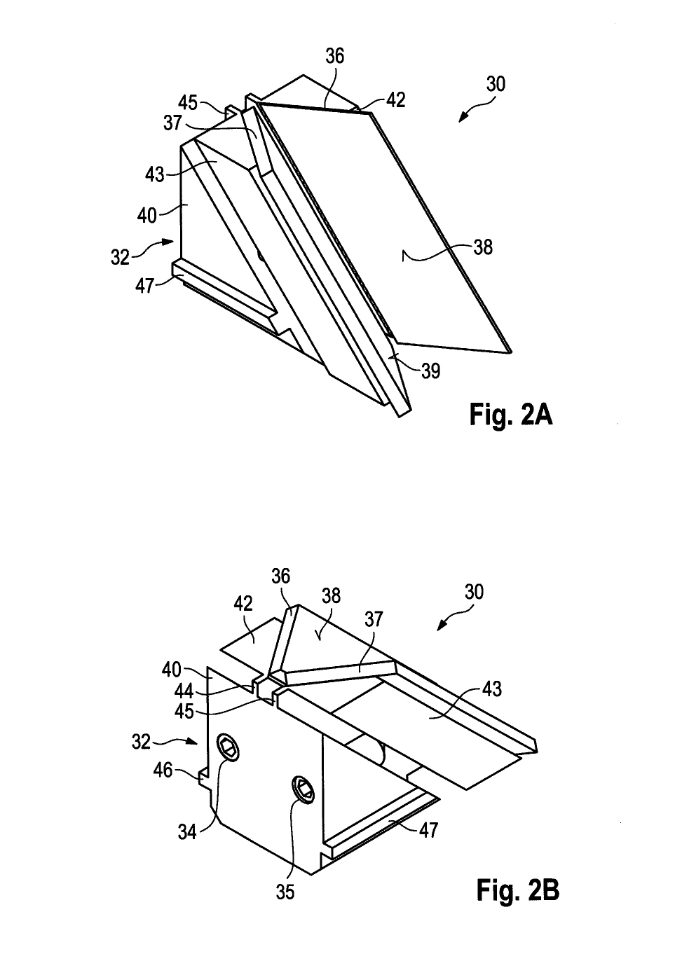

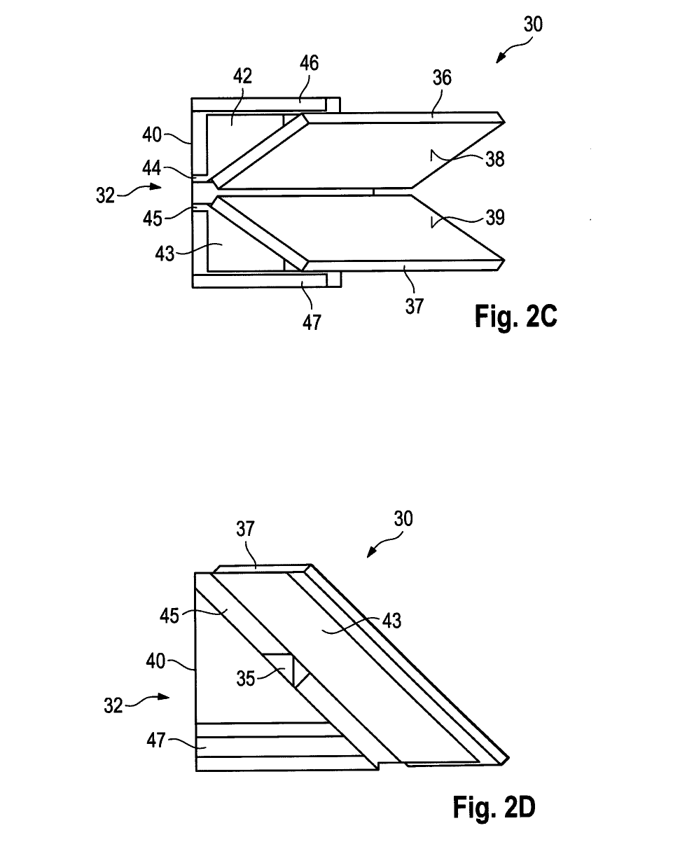

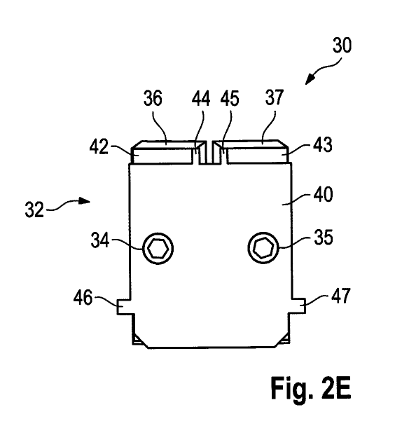

The following is an explanation of the V-mirror unit 30 with reference to FIGS. 2A to 2E. FIG. 2A and FIG. 2B are each perspective views of the V-mirror unit 30 taken from different sides. FIG. 2C is a top view, FIG. 2D is a side view and FIG. 2E is a rear view of the V-mirror unit 30.

The V-mirror unit 30 includes a mounting bracket 32, two adjustment screws 34, 35 and a V-shaped mirror 36, 37. In the embodiment shown in FIGS. 2A to 2E, the V-shaped mirror 36, 37 includes two mirror halves 36 and 37 that are arranged at an angle, in particular at about 90 degrees. Accordingly, the term “mirror” as used in the present specification may also refer to a mirror arrangement constituted by two separate mirror halves. The two mirror halves 36 and 37 are separated by a small slit. Accordingly, each of the two mirror halves 36 and 37 can be tilted independently from one another, as will be explained further below, without exerting stress on the other of the mirror halves. The mirror half 36 has a plane reflection surface 38 and the mirror half 37 has a plane reflection surface 39. The V-shaped mirror 36, 37 thus has two plane reflection surfaces 38, 39 that are arranged at an angle to each other, so that the cross-section of the V-shaped mirror 36, 37 is substantially V-shaped. The angle between the reflection surfaces 38, 39 is about 90 degrees. The V-mirror unit 30 may be approximately 30 mm long, 20 mm wide and 20 mm high, but those dimensions may, of course, be adapted as suitable. As discussed in more detail further below, it is also possible that the V-shaped mirror 36, 37 is constituted by a single V-shaped angular element that is provided with the two plane reflection surfaces 38, 39.

The mounting bracket 32 includes a base portion 40, two mirror support portions 42, 43 for supporting the two mirror halves 36 and 37 of the V-shaped mirror 36, 37, and two connection webs 44, 45. The mirror support portions 42, 43 are connected to the base portion 40 of the mounting bracket 32 through the connection webs 44, 45. The base portion 40, the mirror support portions 42, 43 and the connection webs 44, 45 are constituted by a single component that may be made of milled aluminum, for example. Furthermore, two rails 46, 47 protrude from the side faces of the base portion 40. The rails 46, 47 extend parallel to the bottom face of the base portion 40 at a relatively low height. The rails 46, 47 serve for reliably affixing the V-mirror unit 30 to a frame or housing, as will be explained further below.

The base portion 40 has approximately the shape of a triangular prism. Its sides (see FIG. 2D), have the shape of a right-angled isosceles triangle. The connection webs 44, 45 extend from the side corresponding to the hypotenuse of this right-angled triangle, and are arranged parallel to each other in close proximity. The connection webs 44, 45 elastically connect the support portions 42, 43 to the base portion 40.

The support portions 42, 43 each also have approximately the shape of a triangular prism, whose cross-section is that of a right-angled isosceles triangle. The hypotenuse sides of the two triangular prisms serve as a support for the V-shaped mirror 36, 37. One of the lateral sides of the support portions 42, 43 is disposed parallel to and facing the hypotenuse side of the base 40. The other lateral side of the support portions 42, 43 is arranged parallel to but slightly receded with respect to the lateral side of the base 40. Thus, the support portions 42, 43 form a wing-like arrangement for supporting the V-shaped mirror 36, 37. Then connection webs 44, 45 that connect the support portions 42, 43 to the base portion 40 are so thin, that the support portions 42, 43 can be elastically tilted with respect to the base 40. More specifically, by applying a force to the rear side of the support portion 42 or 43, the respective support portion 42 or 43 tilts (i.e. rotates) with respect to the base portion 40, with the axis of the connection web 44 or 45 serving as the fulcrum (i.e. rotation axis).

An adjustment mechanism is provided for effecting such a tilting of the support portions 42, 43 with respect to the base 40. In the present embodiment, the adjustment mechanism is constituted by two adjustment screws 34, 35, but there is no limitation to this. The two adjustment screws 34, 35 may be headless screws that are arranged in screw holes, which are provided in the base portion 40. These screw holes are each formed at a height corresponding to, for example, approximately half the height of the base portion 40 and extend parallel to the bottom face of the base portion 40. The screws 34, 35 are screwed into the screw holes from the rear side of the base portion 40 and project from the hypotenuse side of the base portion 40 toward the support portions 42, 43. The tip of the screws 34, 35 is conical, with a cone angle that corresponds to the angle by which the rear side of the support portions 42, 43 is inclined with respect to the bottom face of the base portion 40. Thus, the contact area between the screws 34, 35 and the support portions 42, 43 can be maximized to a line-shaped contact area. By turning the screws 34, 35, the tip of the screws 34, 35 advances and exerts a force on the rear side of the support portions 42, 43, thereby elastically deforming the mounting bracket 32 and tilting the support portions 42, 43 in the above-describe manner.

The mirror halves 36 and 37 of the V-shaped mirror are respectively affixed to the support portions 42, 43, for example by adhering them thereto with an epoxy adhesive or the like. The mirror halves 36 and 37 of the V-shaped mirror can be flexibly tilted with respect to each other to a certain degree. Thus, by actuating the screws 34, 35, it is possible to freely adjust the angle between the mirror surfaces 38, 39 of the V-shaped mirror 36, 37. Furthermore, since the angle is adjusted with adjustment screws, it can be adjusted with very high precision. Moreover, the angle can be adjusted even after affixing the mirror unit 30 to a frame or housing. A method for suitably adjusting this angle is explained further below.

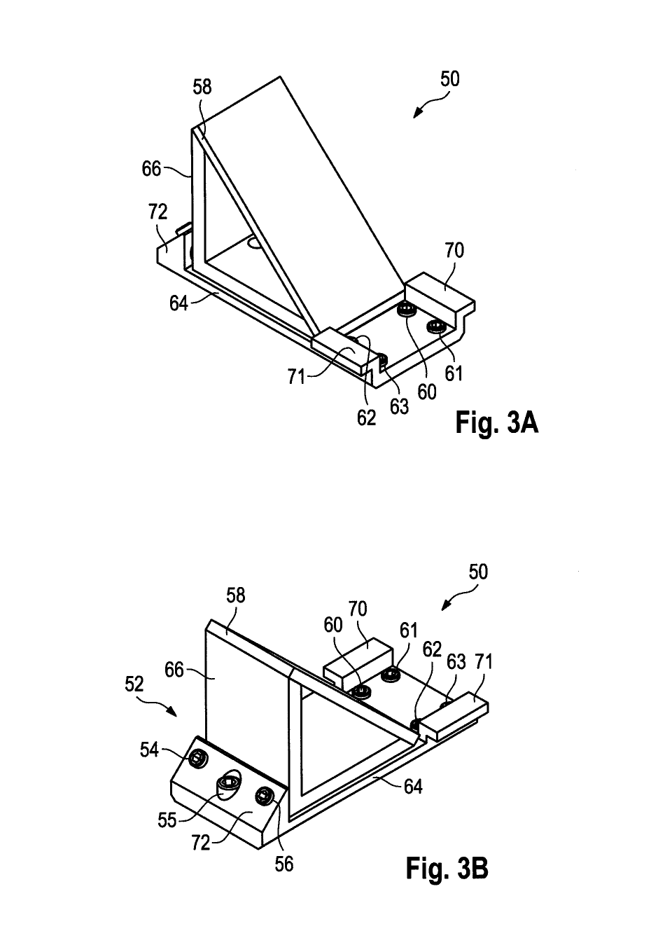

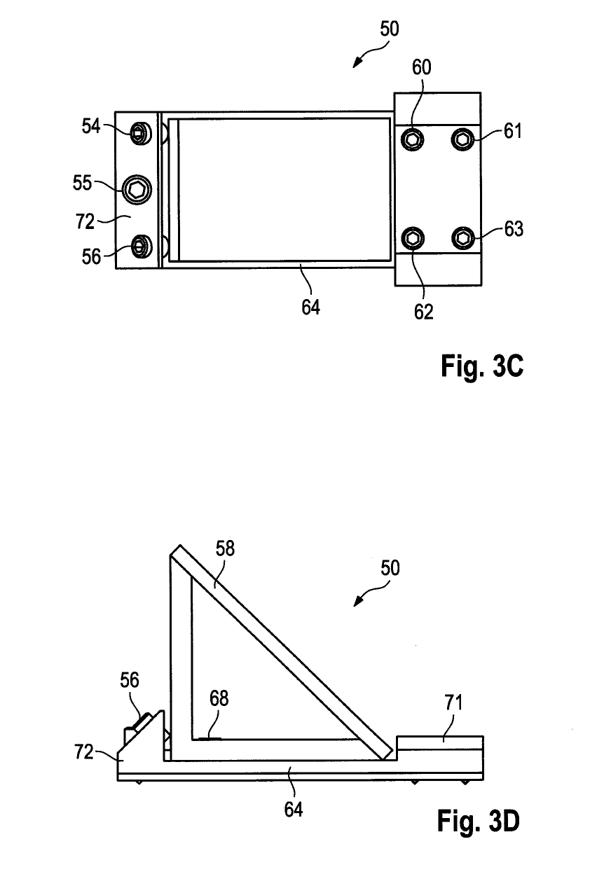

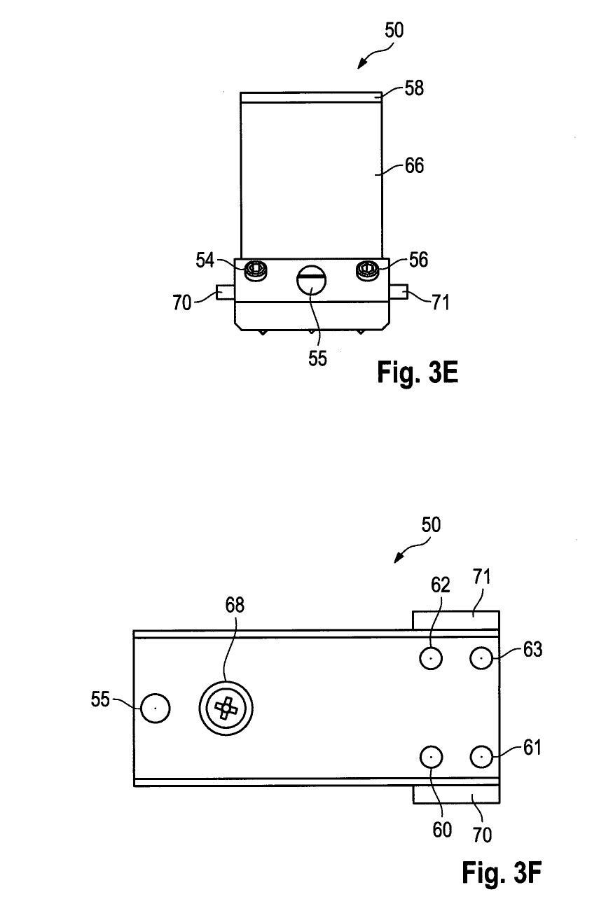

The following is an explanation of the plane mirror unit 50 with reference to FIGS. 3A to 3F. FIG. 3A and FIG. 3B are each perspective views of the plane mirror unit 50 taken from different sides. FIG. 3C is a top view, FIG. 3D is a side view, FIG. 3E is a rear view and FIG. 3F is a bottom view of the plane mirror unit 50.

The plane mirror unit 50 includes a mounting bracket 52, three adjustment screws 54, 55, 56, a plane mirror 58 and four mounting screws 60, 61, 62 and 63. The mounting bracket 52 includes a base portion 64, a mirror support portion 66 for supporting the plane mirror 58, and a swivel bearing 68. The mirror support portion 66 is made of an angular profile element with two shanks that define a right angle. The plane mirror 58 is affixed to the two free ends of the mirror support portion 66. The vertical shank is slightly shorter than the horizontal shank, so that in the unadjusted state, the plane mirror 58 is arranged at an angle of about 42 to 43 degrees with respect to the horizontal shank. Also the mounting bracket 52 may be made of milled aluminum, for example. The plane mirror unit 50 may be, for example, approximately 35 mm long, 20 mm wide and 20 mm high, but those dimensions may, of course, be adapted as suitable.

The base portion 64 includes a plate-shaped base on which the mirror support portion 66 is mounted. At the front end of the base portion 64 (right side in FIGS. 3C and 3D, upper side in FIG. 1), the four mounting screws 60, 61, 62 and 63 are provided, with which the plane mirror unit 50 can be affixed to a frame or housing, as will be explained further below. Furthermore, L-shaped rails 70, 71 protrude from opposite sides of the base portion 64. The rails 70, 71 extend parallel to the bottom face of the base portion 64. The rails 70, 71 serve for reliably affixing the plane mirror unit 50 to a frame or housing, as will be explained further below. At the rear end of the base portion 64, a rear wall 72 rises up from the base portion 64. The front side of the rear wall 72, which faces the mirror support portion 66, is flat and extends parallel to the upright shank of the mirror support portion 66. The rear side of the rear wall 72 is slanted and slopes at an angle of about 45 degrees with respect to the front side of the rear wall 72. Accordingly, the upper portion of the rear wall 72 has an approximately triangular cross-section.

The mirror support portion 66, with the plane mirror 58 affixed to it, is arranged on the base portion 64 between the rear wall 72 and the L-shaped rails 70, 71. The orientation of the mirror support portion 66 is such that its bottom shank is arranged flat, i.e. extending parallel to, the base portion 64, and its upright shank extends upright from the base portion 64 on the rear side thereof, facing the rear wall 72. The mirror support portion 66 is attached to the base portion 64 with the swivel bearing 68. More specifically, the swivel bearing 68 is arranged in the bottom shank of the mirror support portion 66 in close proximity to the upright shank, fixing the mirror support portion 66 to the base portion 64. There is a certain clearance between the rear wall 72 and the mirror support portion 66 (more specifically, the rear side of the upright shank) and there is also a certain clearance between the rear end of the rails 70, 71 and the mirror support portion 66 (more specifically, the front end of the bottom shank). Accordingly, the mirror support portion 66 is afforded with a certain play, so that as long as it is not fixated with the adjustment mechanism as explained below, it can be rotated to a certain degree between the rails 70, 71 and the real wall 72, with the swivel bearing 68 as the fulcrum.

Also the plane mirror unit 50 is provided with an adjustment mechanism for adjusting the orientation of the plane mirror unit 50. In the present embodiment, the adjustment mechanism is constituted by three adjustment screws 54, 55 and 56, but there is no limitation to this. The three adjustment screws 54, 55 and 56 may be headless screws that are arranged in screw holes, which are provided in the rear wall 72 of the base portion 64.

The adjustment screws 54, 56 serve to adjust the rotation angle of the mirror support portion 66 with respect to the base portion 64. More specifically, the screws 54, 56 are provided in screw holes arranged on opposite sides of the rear wall 72. These screw holes are bored perpendicularly to the (slanted) rear side of the rear wall 72. Accordingly, the screws 54, 56 are arranged at an angle of about 135 degrees with respect to the base portion 64 and about 45 degrees with respect to the rear side of the upright shank of the mirror support portion 66. The screws 54, 56 are screwed into the screw holes from the rear side of the rear wall 72 and project from the front side of the rear wall 72 toward the mirror support portion 66. The tip of the screws 54, 56 may be conical or flat. By turning one of the screws 54 or 56, the tip of that screw 54 or 56 advances and exerts a force on the rear side of the support portion 66, thereby turning the support portion 66 around the swivel bearing 68. Once the support portion 66 has been turned to the desired rotation degree with respect to the base portion 64, it can be fixated in this position by turning and advancing the other of the screws 54 and 56. Thus, the support portion 66 can be adjusted to any desired rotation degree within the afforded play.

The adjustment screw 55 serves to adjust the tilt angle of the mirror support portion 66 with respect to the base portion 64. More specifically, the screw 55 is provided in a screw hole in the rear wall 72 that is bored perpendicularly to the base portion 64, i.e. at an angle of 45 degrees with respect to the screw holes of the adjustment screws 54, 56. Accordingly, the screw 55 is arranged perpendicularly to the base portion 64 and its tip extends from the bottom face of the base portion 64. The adjustment of the tilt angle of the mirror support portion 66 with respect to the base portion 64 can be accomplished as follows: First, the plane mirror unit 50 is attached to a frame. For this, the rails 70, 71 are slid into corresponding grooves in the frame, and the mounting screws 60 to 63 are screwed into a bottom surface of the frame. In this situation, the mirror unit 50 is fixedly attached to the frame at its front end by the mounting screws 60 to 63. The rear end of the base portion 64 can now be raised by advancing the adjustment screw 55. This will increase the length of the adjustment screw 55 that protrudes from the bottom face of the base portion 64, thus flexing the base portion 64 upward. As a result, the mirror support portion 66, and thus the mirror 58 is tilted frontward, or in other words, rotated clockwise in FIG. 3D. Thus, the angle defined by the plane mirror 58 and the longitudinal direction of the frame 80 can be adjusted from about 42 or 43 degrees to the desired angle (ordinarily approximately 45 degrees), as necessary.

Accordingly, with the adjustment mechanism of the present embodiment, it is possible to adjust the orientation of the plane mirror unit 50 with regard to two degrees of freedom, namely by rotating it around the axis of the swivel bearing 68 and by rotating it around an axis that is perpendicular thereto. Also, as in the case of the V-mirror unit 30, by using adjustment screws, it is possible to freely adjust the orientation of the mirror surface of the plane mirror 58 with very high precision. Moreover, the tilt angle of the plane mirror 58 can be adjusted even after affixing the plane mirror unit 50 to a frame or housing.

The following is an explanation of a method for assembling and adjusting a reflector unit 20 including a V-mirror unit 30 and a plane mirror unit 50 as described above.

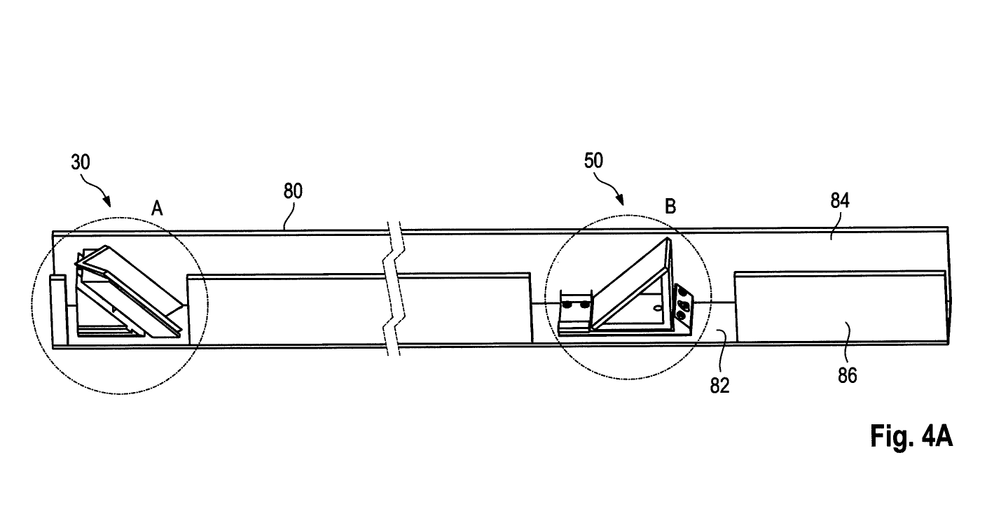

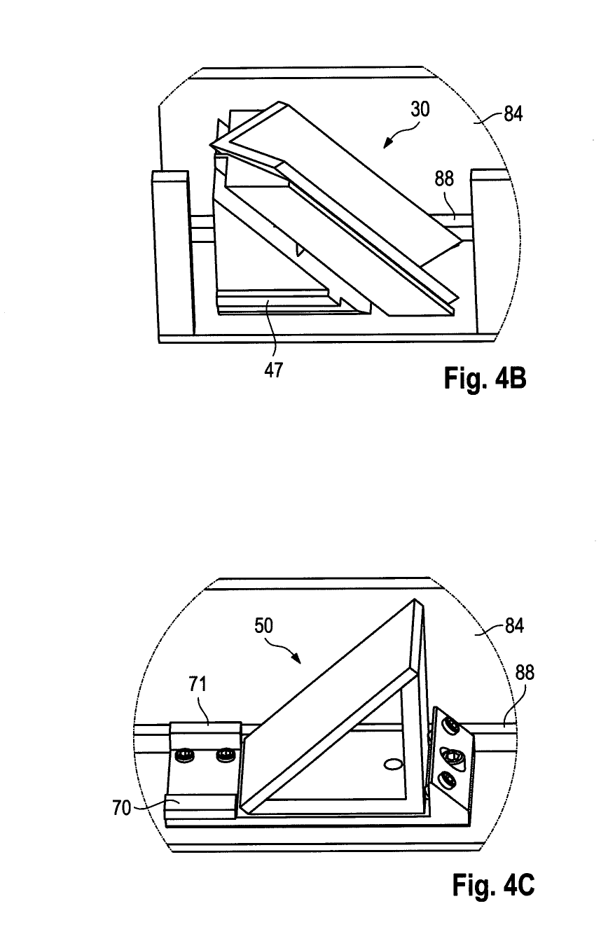

FIG. 4A is a partially cut-away view of the frame 80 of the reflector unit 20, to which the V-mirror unit 30 and the plane mirror unit 50 are mounted. For illustrative reasons, only the two end regions of the frame 80 are shown. FIG. 4B is an enlarged view of the region enclosed by the circle A in FIG. 4A, which includes the V-mirror unit 30. FIG. 4C is an enlarged view of the region enclosed by the circle B in FIG. 4A, which includes the plane mirror unit 50.

It should be noted that the embodiment shown in FIGS. 4A to 4C, the V-shaped mirror of the V-mirror unit 30 is constituted by a single V-shaped angular element that is provided with the two plane reflection surfaces, instead of two mirror halves as in the embodiment shown in FIGS. 2A to 2E. Providing the V-shaped mirror as a single V-shaped angular element has the advantage of reducing the number of parts, but providing the V-shaped mirror as two separate mirror halves has the advantage that when adjusting one mirror half, no forces are transmitted to the other mirror half. If the V-shaped mirror is provided as two separate mirror halves, then the slit between the mirror halves should be small enough that the mirror halves are substantially functionally equivalent to a corresponding V-shaped mirror made of a single angular element.

The frame 80 has an approximately U-shaped cross-section, having a bottom wall 82 and two side walls 84 and 86. It should be noted that the side walls 84 and 86 extend all the way from the front end to the rear end of the frame 80, but for illustrative reasons, the portions of the side wall 86 where the mirror units 30 and 50 are arranged are shown as cut-away. Furthermore, a groove 88 is provided near the bottom end of each of the side walls 84 and 86 (only the groove 88 on the side of the side wall 84 is shown in the figures).

In a first step, the mirror units 30 and 50 are provisionally mounted to the frame 80 by sliding the rails 46, 47 and 70, 71 into the grooves 88. The rails 46, 47, 70, 71 and the grooves 88 may be dimensioned such that when the mirror units 30 and 50 are slid into the grooves 88, the side faces of the mirror units 30 and 50 are at least partially in areal contact with the side walls of the frame 80. Furthermore, the plane mirror unit 50 is affixed to the bottom wall 82 of the frame 80 by screwing the mounting screws 60 to 63 to corresponding screw holes (not shown) in the bottom wall 82. Thus, the mirror units 30 and 50 are mounted mechanically to the frame 80.

In a second step, an adhesive is applied to the V-mirror unit 30, in order to glue the V-mirror unit 30 to the frame 80. An epoxy-based adhesive can be used for this, but any other suitable adhesive may be used as well. The adhesive is applied to the interface between the V-mirror unit 30 and the frame 80. It should be noted that this interface includes the side faces of the base portion 40, but does not included the side face of the mirror support portions 42, 43, which are accordingly not glued to the frame 80. Moreover, a clamp arrangement may be used to fix the V-mirror unit 30 in a predetermined position while the adhesive dries, which may take about 24 hours, for example. It should be noted that also the plane mirror unit 50 may be glued to the frame 80 in a similar manner, however it is also sufficient if the plane mirror unit 50 is fixed with the screws 60 to 63.

Clamping and gluing the V-mirror unit 30 makes it possible to position the V-mirror unit 30 with a certain degree of precision to the frame 80. However, slight local variations in the amount of adhesive that is applied as well as temperature variations and the like may result in uneven drying of the adhesive. The result may be local stresses in the V-mirror unit 30 that lead to a slight positional displacement of the mirror surfaces 38, 39. This positional displacement can be corrected through an adjustment (calibration) with the adjustment mechanism of the present embodiment.

In a third step, two parallel laser beams are directed at the mirror system, for example at the V-mirror unit 30. The laser beams are arranged to be incident on the V-mirror unit 30 in such a direction that the beams reflected by the V-shaped mirror 36, 37 are propagated in the longitudinal direction of the frame 80. It should be noted that each of the laser beams is reflected twice by the V-shaped mirror 36, 37, namely once by the mirror surface 38 and once by the mirror surface 39 (in this or the opposite order). Then, the angle between the mirror surfaces 38, 39 is adjusted by actuating the adjustment screws 34, 35. First, the angle between the mirror surfaces 38, 39 is adjusted such that both laser beams reflected by the V-shaped mirror 36, 37 propagate in parallel in longitudinal direction of the frame 80 and are both incident on the plane mirror 58. To assist this adjustment operation, a jig provided with holes or markings may be placed in the frame 80 between the V-shaped mirror 36, 37 and the plane mirror 58. By sliding the jig in longitudinal direction along the frame 80, it is possible to observe the propagation direction of the reflected laser beams in the frame 80 while adjusting the V-mirror unit 30 as appropriate.

In a fourth step, the laser source is first adjusted such that a single laser beam is incident on the center of the V-shaped mirror 36, 37, that is, on the border between the mirror surfaces 38 and 39. Then, the angle between the mirror surfaces 38, 39 is further fine-tuned in such a manner that the two reflected light beams reflected by the mirror system overlap at a predetermined target distance from the reflector unit. This predetermined target distance may correspond to the desired operating distance between the transmitter/receiver unit 10 and the reflector unit 20. Moreover, the predetermined target distance may be, for example, in a range of 12 to 20 m, but there is of course no limitation to this.

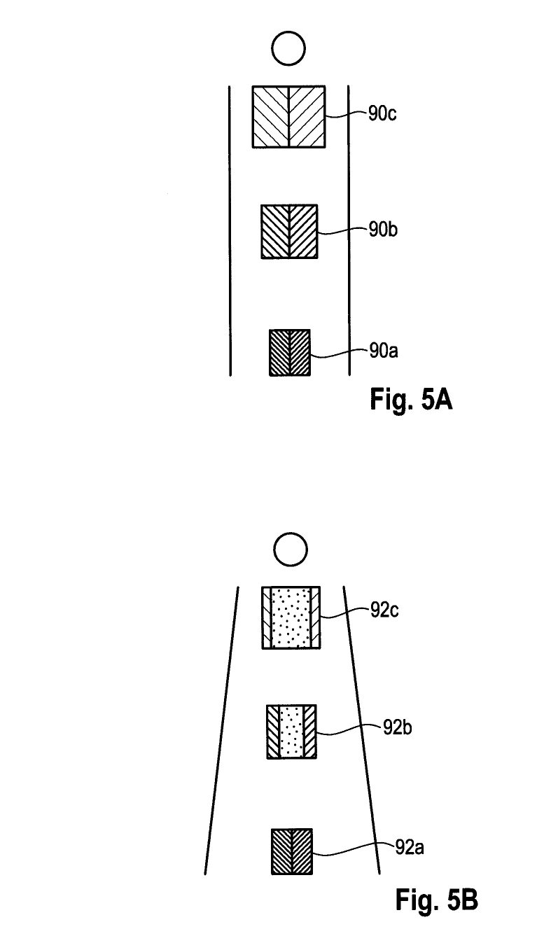

The reason for adjusting the angle between the mirror surfaces 38, 39 in this manner is explained in the following with reference to the FIGS. 5A and 5B. It should be noted that in an actual light curtain, the transmitter 12 is constituted by an LED, i.e. a divergent light source. FIG. 5A schematically illustrates the change of the cross-section of such a divergent light beam at various distances after the mirror system for the case that the angle between the mirror surfaces 38, 39 is adjusted to precisely 90 degrees. Numeral 90a denotes a schematic cross-section of the divergent light beam immediately after the mirror system, e.g. at a distance of 0.1 m. Needless to say, the cross-section of the light beam is not necessarily rectangular, FIGS. 5A and 5B are merely a schematic representation of the change of the cross-section. The light beam includes two portions that are reflected by the mirror surfaces 38 and 39 in different order. One portion of the light beam is first reflected by the mirror surface 38 and then reflected by the mirror surface 39 whereas the other portion of the light beam is first reflected by the mirror surface 39 and then reflected by the mirror surface 38. The two portions are illustrated by different hatchings. Numeral 90b denotes a schematic cross-section of the divergent light beam at a certain distance from the mirror system, e.g. at a distance of 9 m. Due to the divergence of the light beam, the cross-section of the light beam increases, and the light intensity weakens. This becomes increasingly so with increasing distance, as shown by numeral 90c which denotes a schematic cross-section of the light beam even further away, e.g. at 18 m, which may correspond to the target distance.

By contrast, FIG. 5B illustrates the situation of the divergent light beam for the case that the mirror system has been calibrated in the above-described manner, i.e. by adjusting the angle between the mirror surfaces 38, 39 such that the two laser beams overlap at the target distance. In this case, the cross-section 92a of the divergent light beam immediately after the mirror system is approximately the same as in FIG. 5A. After a certain distance from the mirror system, e.g. at a distance of 9 m, there is a certain overlap between the portion of the light beam that has been reflected first by the mirror surface 38 and then by the mirror surface 39 and the portion of the light beam that has been reflected first by the mirror surface 39 and then by the mirror surface 38, as shown by the cross-section 92b. This overlap is the greatest at the target distance of e.g. 18 m, as shown by the cross-section 92c. This state is attained if the angle between the mirror surfaces 38, 39 is slightly smaller than 90 degrees, for example between 89.95 and 89.99 degrees, depending on the distance of the target. Accordingly, the light beam is expanded less, so that a larger light intensity can be attained at the target distance. This has the advantage that with the same light source, a larger target distance can be attained.

In a fifth step, the plane mirror 58 is rotated with respect to the frame 80 by adjusting the adjustment screws 54, 56, and the plane mirror 58 is tilted by adjusting the adjustment screw 55, such that the beam reflected by the mirror system is incident on a predetermined target area. Needless to say, the rotation and the tilting of the plane mirror 58 with the screws 54 to 56 can also be performed iteratively. Moreover, it is also possible to perform the fourth and the fifth step descried above iteratively until the two spots due to the two mirror surfaces 38, 39 overlap at the target area in the target distance. It is furthermore possible to reverse the order of the fourth and fifth steps.

The above-described steps conclude the method for adjusting the reflector unit 20. With this method, it is possible to adjust the orientation of the mirrors in the mirror units 30 and 50 even after the mirror units 30 and 50 have been attached to the frame 80. This makes it possible to correct for stress and positional displacements that have occurred during the curing of the adhesive that fixes the mirror units to the frame 80. As a result, fewer reflector units 20 need to be scrapped due to positional inaccuracies that cannot be corrected. Moreover, the mirror units 30 and 50 can be adjusted in such a manner that a larger light intensity can be achieved at a predetermined target distance. This makes it possible to achieve larger target distances.

To ensure that the adjusted positioning of the mirror units 30 and 50 is maintained and is not lost due to loosening of the screws 34, 35 and 54 to 56, it is possible to apply, in a sixth step, a thread-locking sealant to those screws. Such a thread-locking sealant, which is typically methacrylate-based and cures anaerobically, ensures that the screws are locked in their position and cannot be loosened due to vibrations, temperature changes or the like. The thread-locking sealant may be such that it is not possible to actuate the screws in a non-destructive manner. Thus, if such a thread-locking sealant has been applied to the adjustment screws, the adjustment mechanism, while still being present in the mirror units, is not operable anymore.

Furthermore, assembly of the reflector unit 20 can be concluded in a final step by attaching end plates and a transparent front cover (not shown in the drawings) to the frame 80. The front cover may be made of hard plastic and should be transparent in the wavelength region of the light emitted by the transmitter 12. The frame 80, the front cover and the end plates together constitute a housing of the reflector unit 20.

It should be noted that numerous variations of the above-described embodiments are possible within the scope of the claims.

For example, it is not necessarily required that the screws 34, and 54 to 56 are fixed by a thread-locking sealant. Alternatively, it is also possible to fix the screws 34, 35 and 54 to 56 by other means. If the position of the screws 34, 35 and 54 to 56 is not permanently fixed, then it may be necessary to recalibrate the mirror surfaces in regular intervals.

Moreover, the adjustment mechanism is not limited to screws, but may be realized by any adjustment mechanism that is suitable for adjusting the orientation of the mirror surfaces. For example, instead of screws, it is also possible to use other elements that can apply an adjustable force on a surface, such as bolts or wedges. It is also possible to use actuators, such as motors or piezo actuators, for the adjustment mechanism. In particular piezo actuators may be advantageous in the case that the position of the adjustment mechanism is not locked into place using a sealant or the like. Using piezo actuators, it is possible to control the orientation of the mirror surfaces with very high precision.

Furthermore, in the foregoing embodiment, the support portions 42, 43 each have approximately the shape of a triangular prism, but their shape is not limited to this and they may also be plate-shaped for example. However, if they have approximately the shape of a triangular prism, then a compact and stable arrangement can be achieved.

Moreover, a light curtain 1 with two light axes has been described above. However, the embodiments may also be advantageously applied to light curtains with more axes. For example, configurations are possible, in which several mirror systems, each including a V-mirror unit and a plane mirror unit, are arranged in a single frame. Such an arrangement requires a particularly high degree of precision of the reflecting surfaces, which can be achieved with the above-described configuration.

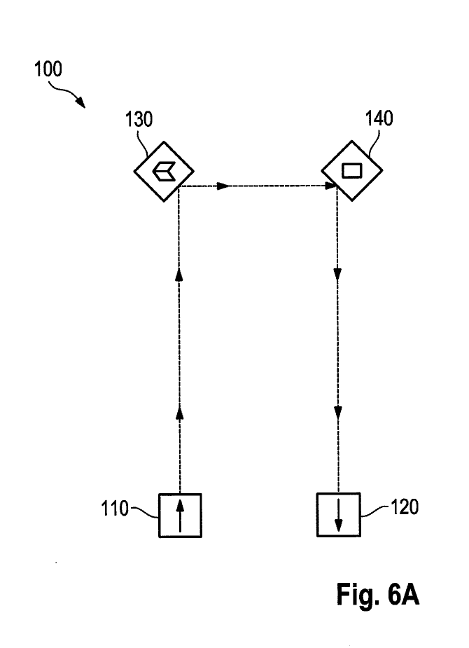

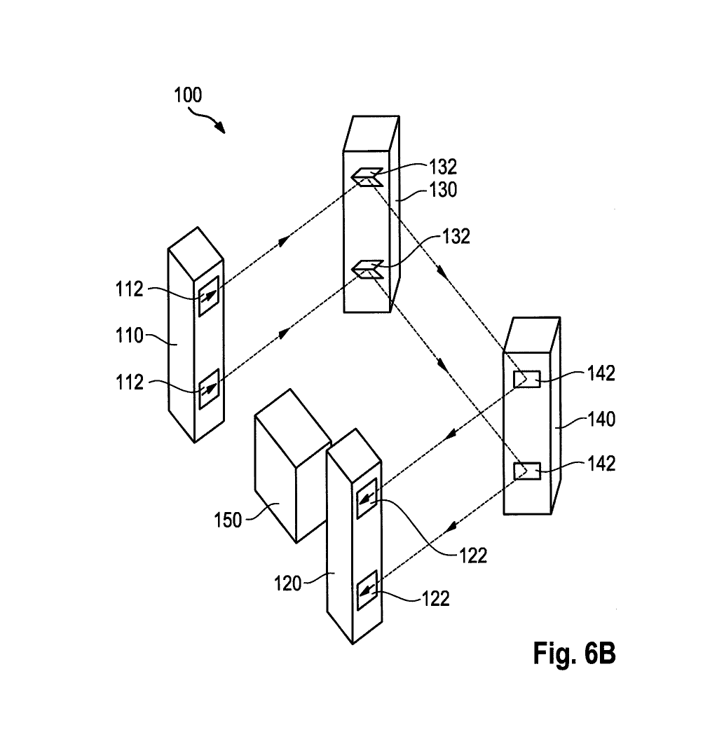

Furthermore, the above-described embodiment relates to an active-passive system. But the embodiments can also be applied to an active-active system. An example of this will be explained in the following with reference to FIGS. 6A and 6B.

FIG. 6A shows a schematic top view of a light curtain 100 in accordance with a further embodiment of the present invention. FIG. 6B shows a schematic perspective view of this light curtain 100.

The light curtain 100 shown in FIGS. 6A and 6B includes a transmitter unit 110, a receiver unit 120, a first reflector unit 130 and a second reflector unit 140, which are arranged at the four corner points of a rectangle. The transmitter unit 110 is provided with two optical transmitters 112 that respectively emit light beams toward the first reflector unit 130. The first reflector unit 130 deflects these light beams toward the second reflector unit 140, which in turn deflects the light beams toward the receiver unit 120. The receiver unit 120 is provided with two optical receivers 122 that receive the two light beams. The structure and operation of the transmitters 112 and the receivers 122 correspond to that of the transmitter 12 and the receiver 14 explained with reference to FIG. 1, so that their further explanation has been omitted.

The transmitter unit 110, the receiver unit 120, the first reflector unit 130 and the second reflector unit 140 are placed around a protected zone, in which a machine 150, such as a robot or the like, may be placed. If the transmitter unit 110 and the receiver 120 unit, which together constitute a transmitter/receiver arrangement, are arranged at a common wall, then the protected zone can be protected from all sides with the light curtain 100. Needless to say, even though FIGS. 6A and 6B show an example for only two light beams, it is also possible to protect the protected zone with three or more light beams, by providing the corresponding number of transmitters, receivers and mirror units.

Different to the previously explained embodiment, the V-mirror units and the plane mirror units are provided in different reflector units. More specifically, the first reflector unit 130 is provided with two V-mirror units 132, and the second reflector unit 140 is provided with two plane mirror units 142. The V-mirror units 132 respectively deflect the incoming light beam by 90 degrees in the horizontal plane toward the corresponding plane mirror units 142. Also the plane mirror units 142 deflect the incoming light beam by 90 degrees in the horizontal plane. Accordingly, the V-mirror units 132 and the plane mirror units 142 are arranged in respective frames (not shown in the drawings) at an orientation that is 90 degrees rotated with respect to that shown in FIG. 1, for example. More specifically, the V-mirror units 132 are arranged such that the line where their two reflecting surfaces meet is disposed in the horizontal plane. Other aspects of the V-mirror units 132 and the plane mirror units 142 correspond to those of the previously explained V-mirror unit 30 and plane mirror unit 50 and are therefore not discussed further here.

The first and second reflector units 130 and 140 thus constitute a reflector arrangement including a mirror system for deflecting incident light. As the V-mirror units 132 and the plane mirror unit 142 are configured as described above, it is possible to attain the same advantageous effect, namely to assemble the mirror system with greater precision, so that a larger operating range can be achieved. Accordingly, the transmitter unit 110, the receiver unit 120, the first reflector unit 130 and the second reflector unit 140 can be placed at a greater distance from one another, so that the area of the protected zone can be increased.

1. A reflector arrangement comprising a mirror system for deflecting incident light, the mirror system comprising:
a V-mirror unit comprising a V-shaped mirror having two mirror reflection surfaces; and
a plane mirror unit arranged at a distance from the V-mirror unit;
wherein
the V-mirror unit comprises a V-mirror adjustment mechanism for adjusting an angle between the two mirror reflection surfaces of the V-shaped mirror.

2. The reflector arrangement according to claim 1, wherein
the V-mirror unit comprises an elastically deformable V-mirror mounting bracket for supporting the V-shaped mirror, and
the V-mirror adjustment mechanism is adapted to elastically deform the V-mirror mounting bracket to adjust the angle between the two mirror reflection surfaces.

3. The reflector arrangement according to claim 2, wherein
the V-mirror mounting bracket comprises:
a base portion; and
two support portions elastically connected to the base portion, each support portion supporting one part of the V-shaped mirror; wherein
the V-mirror adjustment mechanism is adapted to adjust the angle between the two mirror reflection surfaces by tilting of at least one of the support portions relative to the base portion.

4. The reflector arrangement according to claim 3, wherein
the V-mirror adjustment mechanism includes two screws that are mounted in respective screw holes provided in the base portion, wherein
the screws are adapted to apply a force on the respective support portion, thereby adjusting the angle between the two mirror reflection surfaces.

5. The reflector arrangement according to claim 3, wherein
each of the support portions is elastically connected to the base portion by a web; and
the base portion, the support portions and the webs are constituted in a single piece.

6. The reflector arrangement according to claim 1, wherein
the angle between the two mirror reflection surfaces is fixed by a thread-locking sealant that is applied to the V-mirror adjustment mechanism.

7. The reflector arrangement according to claim 1, wherein
the angle between the two mirror reflection surfaces is smaller than 90 degrees.

8. The reflector arrangement according to claim 1,
further comprising a frame to which the V-mirror unit and/or the plane mirror unit are mounted.

9. The reflector arrangement according to claim 8, wherein the plane mirror unit comprises:
a plane mirror;
a plane mirror mounting bracket; and
a plane mirror adjustment mechanism for adjusting the orientation of the plane mirror relative to the frame.

10. The reflector arrangement according to claim 9, wherein
the plane mirror mounting bracket comprises a plane mirror base portion and a plane mirror support portion that is rotatable with respect to the plane mirror base portion, and
the plane mirror adjustment mechanism comprises means for adjusting a rotation angle of the plane mirror support portion with respect to the plane mirror base portion.

11. The reflector arrangement according to claim 10, wherein
the plane mirror adjustment mechanism includes two screws that are mounted in respective screw holes provided in the plane mirror base portion, and wherein
the screws are adapted to apply a force on the plane mirror support portion, thereby rotating the plane mirror support portion with respect to the plane mirror base portion.

12. The reflector arrangement according to claim 1, wherein
the V-mirror adjustment mechanism and/or the plane mirror adjustment mechanism comprises an actuator, in particular a piezo actuator, that can be actuated by an actuation signal.

13. The reflector arrangement according to claim 1, wherein
the mirror system is adapted to reflect incident light that is incident in a predetermined incident direction in a reflection direction that is parallel to the incident direction.

14. The reflector arrangement according to claim 9, wherein
the plane mirror adjustment mechanism includes a screw that is arranged to lift the plane mirror base portion from the frame, thereby rotating the plane mirror support portion with respect to the frame.

15. A light curtain comprising:
the reflector arrangement according to claim 1, and
a transmitter/receiver arrangement for projecting a light beam onto the mirror system and receiving a light beam reflected from the mirror system.

16. A method for adjusting the reflector arrangement according to claim 1, comprising the steps of:
projecting an incident light beam onto the mirror system;
operating the V-mirror adjustment mechanism to adjust the angle between the two mirror reflection surfaces of the V-shaped mirror such that two reflected light beams reflected by the mirror system overlap at a predetermined distance from the reflector arrangement.

17. The method according to claim 16, further comprising:
operating the plane mirror adjustment mechanism such that a reflected light beam reflected by the mirror system is incident on a predetermined target area.

18. A method for assembling a reflector arrangement comprising a mirror system for deflecting incident light, the mirror system comprising:
a V-mirror unit comprising a V-shaped mirror having two mirror reflection surfaces;
a plane mirror unit arranged at a distance from the V-mirror unit; and
a V-mirror adjustment mechanism for adjusting an angle between the two mirror reflection surfaces of the V-shaped mirror
the method comprising the steps of:
mounting the V-mirror unit and the plane mirror unit to the frame; and
adjusting the angle between the two mirror reflection surfaces of the V-shaped mirror by a procedure comprising the steps of:
projecting an incident light beam onto the mirror system; and
operating the V-mirror adjustment mechanism to adjust the angle between the two mirror reflection surfaces of the V-shaped mirror such that two reflected light beams reflected by the mirror system overlap at a predetermined distance from the reflector arrangement.

19. The method according to claim 18, further comprising:
applying a thread-locking sealant to the V-mirror adjustment mechanism or the plane mirror adjustment mechanism to fix their respective adjustment state.

20. The method according to claim 18, further comprising:
applying a thread-locking sealant to the V-mirror adjustment mechanism and the plane mirror adjustment mechanism to fix their respective adjustment state.
